(19) United States
(12) Patent Application Publication
(10) Pub. No.: US 2014/0239762 A1
(43) Pub. Date: Aug. 28, 2014

(54) APPARATUS, SYSTEMS AND METHODS FOR REDUCING NOISE GENERATED BY ROTATING COUPLINGS

(71) Applicant: MagnaDrive Corporation, Woodinville, WA (US)

(72) Inventors: Dan Durland, Seattle, WA (US); Jason Covey, Issaquah, WA (US); Mike Tomczak, Stanwood, WA (US); Jeongkwan Lee, Houston, TX (US); Stephen Knudsen, Edmonds, WA (US)

(73) Assignee: MagnaDrive Corporation, Woodinville, WA (US)

(21) Appl. No.: 14/180,061

(22) Filed: Feb. 13, 2014

Related U.S. Application Data
(60) Provisional application No. 61/770,003, filed on Feb. 27, 2013.

(51) Int. Cl. H02K 49/04; B23P 6/00

(52) U.S. Cl. CPC H02K 49/046; B23P 6/00
USPC 310/105; 165/185; 29/402.08

(57) ABSTRACT

A heat sink element for an adjustable speed magnetic drive unit operable by relative rotation of a conductor rotor assembly and a magnet rotor assembly includes a base portion and a plurality of groupings of fins. The base portion includes a mounting face that is sized and dimensioned to be coupled to the conductor rotor assembly, and an opposing convective heat transfer face. The plurality of groupings of fins extend from the convective heat transfer face of the base portion. Adjacent fins in each grouping of fins are separated by a channel that extends along a longitudinal direction of the fins. The plurality of groupings of fins are separated by at least one slot that extends substantially transverse to the longitudinal direction.

### BACKGROUND

1. Technical Field

The present disclosure relates to heat sink assemblies and associated retrofit methods for adjustable speed magnetic drive systems.

2. Description of the Related Art

Adjustable speed magnetic drive systems operate by transmitting torque from a motor to a load across an air gap. There is no mechanical connection between the driving and driven sides of the equipment. Torque is created by the interaction of powerful rare-earth magnets on one side of the drive with induced magnetic fields on the other side. By varying the air gap spacing, the amount of torque transmitted can be controlled, thus permitting speed control.

Conventionally, adjustable speed drives of this type consist of three sets of components. A magnet rotor assembly, containing rare-earth magnets, is attached to the load. A conductor rotor assembly is attached to the motor. The conductor rotor assembly includes a rotor made of a conductive material, such as aluminum, copper, or brass. Actuation components control the air gap spacing between the magnet rotors and the conductor rotors. Relative rotation of the conductor and magnet rotor assemblies induces a powerful magnetic coupling across the air gap. Varying the air gap spacing between the magnet rotors and the conductor rotors results in controlled output speed. The output speed is adjustable, controllable, and repeatable.

The principle of magnetic induction requires relative motion between the magnets and the conductors. This means that the output speed is always less than the input speed. The difference in speed is known as slip. Typically, slip during operation at a full rating motor speed is between 1% and 3%.

The relative motion of the magnets in relation to the conductor rotor causes eddy currents to be induced in the conductor material. The eddy currents in turn create their own magnetic fields. It is the interaction of the permanent magnet fields with the induced eddy current magnetic fields that allow torque to be transferred from the magnet rotor to the conductor rotor. The electrical eddy currents in the conductor material create electrical heating in the conductor material.

Conventionally, fins are arranged on an external surface of the conductor rotors to aid in the removal of heat during operation of the drive unit. FIGS. 1 and 2 illustrate one such conventional configuration. An adjustable speed drive 10 includes conductor rotors 12 and 14 coupled together by spacers 16. A plurality of heat transfer elements 20 are circumferentially arrayed on an external surface of the conductor rotors 12 and 14. As shown in FIGS. 2A-2C, each heat transfer element 20 includes a plurality of fins 26 that extend from a base 22 to define a plurality of channels 28 between the fins 26. The heat transfer elements 20 can be secured to the conductor rotors 12 and 14 via openings 24 in the base 22. The heat transfer elements 20 are coupled to the conductor rotors 12 and 14 such that the fins 26 and channels 28 extend in a substantially radial direction relative to an axis of rotation of the conductor rotors 12 and 14. As the adjustable speed drive is operated, the rotation of the rotors 12 and 14 causes air to flow radially outward through the channels 28, thereby cooling the conductor rotors 12 and 14.

### BRIEF SUMMARY

It has been observed that the inclusion of heat sink assemblies on the conductor rotors of an adjustable speed drive generate an unacceptable amount of noise during operation. It has been further observed that by reducing the fin height on the heat sinks, sound levels can be reduced to acceptable ranges for lower speed operation of the adjustable speed drive. It has also been observed that including slots across the fins and heat sink elements also has a favorable effect on sound level reduction, including at high speeds of operation.

A heat sink element for an adjustable speed magnetic drive unit operable by relative rotation of a conductor rotor assembly and a magnet rotor assembly may be summarized as including a base portion that includes a mounting face that is sized and dimensioned to be coupled to the conductor rotor assembly, and an opposing convective heat transfer face; a plurality of groupings of fins extending from the convective heat transfer face of the base portion, adjacent fins in each grouping of fins separated by a channel that extends along a longitudinal direction of the fins, the plurality of groupings of fins being separated by at least one slot that extends substantially transverse to the longitudinal direction. A height of the fins in each grouping may vary across the grouping. The height of the fins may increase linearly towards a centerline of the heat sink element to form a tented profile. A height of the fins in each grouping may vary across the grouping to form a non-linear, curved profile. The plurality of groupings of fins may be separated by more than two slots that extend substantially transverse to the longitudinal direction.

An adjustable speed magnetic drive unit may be summarized as including a magnet rotor assembly; a conductor rotor assembly positioned relative to the magnet rotor assembly such that there is an air gap between the magnet rotor assembly and the conductor rotor assembly, and such that relative rotation of the conductor and magnet rotor assemblies induces a magnetic coupling across the air gap; and a heat sink assembly coupled to the conductor assembly, the heat sink assembly including a plurality of groupings of fins arrayed in a substantially circumferential direction relative to an axis of rotation of the conductor assembly, the plurality of circumferential arrays of fins being separated by at least one slot that extends substantially transverse to a radial direction relative to the axis of rotation of the conductor rotor assembly. The heat sink assembly may include a plurality of heat sink elements that are arranged on an external surface of the conductor rotor assembly, each heat sink element including the plurality of groupings of fins. On at least one of the heat sink assemblies, a height of the fins within each of the plurality of groupings of fins may vary across the respective grouping of fins. On the at least one of the heat sink assemblies, the fins may define a tented profile. On the at least one of the heat sink assemblies, the fins may define a curved profile. Each heat sink element may include more than two slots that extends substantially transverse to the radial direction.

A method of reducing noise generated by an adjustable speed magnetic drive unit that is operable by relative rotation of a conductor rotor assembly and a magnet rotor assembly may be summarized as including removing a first heat sink element from the conductor rotor assembly, the first heat sink element including a first plurality of fins that extend in a substantially radial direction relative to an axis of rotation of the conductor rotor assembly; and then coupling a second heat sink element to the conductor rotor assembly in place of the first heat sink element, the second heat sink element including a second plurality of fins that extend in a substantially radial direction relative to the axis of rotation of the conductor rotor assembly, a total exposed surface area of the second plurality of fins being less than a total exposed surface area of the first plurality of fins. An average fin height of the first plurality of fins may be greater than an average fin height of the second plurality of fins. The first plurality of fins may extend uninterrupted in the radial direction on the first heat sink element, and the second plurality of fins may include at least one slot that extends substantially transverse to the radial direction and separates the second plurality of fins into at least two radial groupings. An average fin height of the first plurality of fins may be substantially the same as an average fin height of the second plurality of fins.

### BRIEF DESCRIPTION OF THE SEVERAL VIEWS OF THE DRAWINGS

In the drawings, identical reference numbers identify similar elements or acts.

FIG. 1A is an isometric view of a conventional heat sink arrangement on an adjustable speed drive.

FIG. 1B is a front view of the adjustable speed drive of FIG. 1A.

FIG. 1C is a left side view of the adjustable speed drive of FIG. 1A.

FIG. 1D is a right side view of the adjustable speed drive of FIG. 1A.

FIG. 2A is a top view of a conventional heat sink of the adjustable speed drive of FIGS. 1A-1D.

FIG. 2B is a front view of the heat sink of FIG. 2A.

FIG. 2C is an isometric view of the heat sink of FIG. 2B.

FIG. 3 shows the sound levels generated by various heat sink arrangements at various rotational speeds for adjustable speed drives.

FIG. 4A is a top view of a heat sink element having a reduced fin height relative to the heat sink element shown in FIGS. 2A-2C.

FIG. 4B is a front view of the heat sink element of FIG. 4A.

FIG. 4C is an isometric view of the heat sink element of FIG. 4A.

FIG. 5A is an isometric view of an adjustable speed drive according to one aspect of the present disclosure.

FIG. 5B is a front view of the adjustable speed drive of FIG. 5A.

FIG. 5C is a left side view of the adjustable speed drive of FIG. 5A.

FIG. 5D is a right side view of the adjustable speed drive of FIG. 5A.

FIG. 6A is a top view of a heat sink element used with the adjustable speed drive of FIG. 5A.

FIG. 6B is a front view of the heat sink element of FIG. 6A.

FIG. 6C is an isometric view of the heat sink element of FIG. 6A.

FIG. 7A is an adjustable speed drive according to another aspect of the present disclosure.

FIG. 7B is a front view of the adjustable speed drive of FIG. 7A.

FIG. 7C is a left side view of the adjustable speed drive of FIG. 7A.

FIG. 7D is a right side view of the adjustable speed drive of FIG. 7A.

FIG. 8A is a top view of a heat sink element used with the adjustable speed drive illustrated in FIGS. 7A-7D.

FIG. 8B is a front view of the heat sink element shown in FIG. 8A.

FIG. 8C is an isometric view of the heat sink element shown in FIG. 8A.

FIG. 9A is a top view of a heat sink element according to another aspect of the present disclosure.

FIG. 9B is a front view of the heat sink element of FIG. 9A.

FIG. 9C is an isometric view of the heat sink element of FIG. 9A.

FIG. 10A is a top view of a heat sink element according to another aspect of the present disclosure.

FIG. 10B is a front view of the heat sink element of FIG. 10A.

FIG. 10C is an isometric view of the heat sink element of FIG. 10A.

FIG. 11A is top view of a heat sink element according to another aspect of the present disclosure.

FIG. 11B is a front view of the heat sink element of FIG. 11A.

FIG. 11C is an isometric view of the heat sink element of FIG. 11A.

### DETAILED DESCRIPTION

In the following description, certain specific details are set forth in order to provide a thorough understanding of various embodiments of the invention. However, one skilled in the art will understand that the invention may be practiced without these details.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The Abstract of the Disclosure provided herein is for convenience only and does not interpret the scope or meaning of the embodiments.

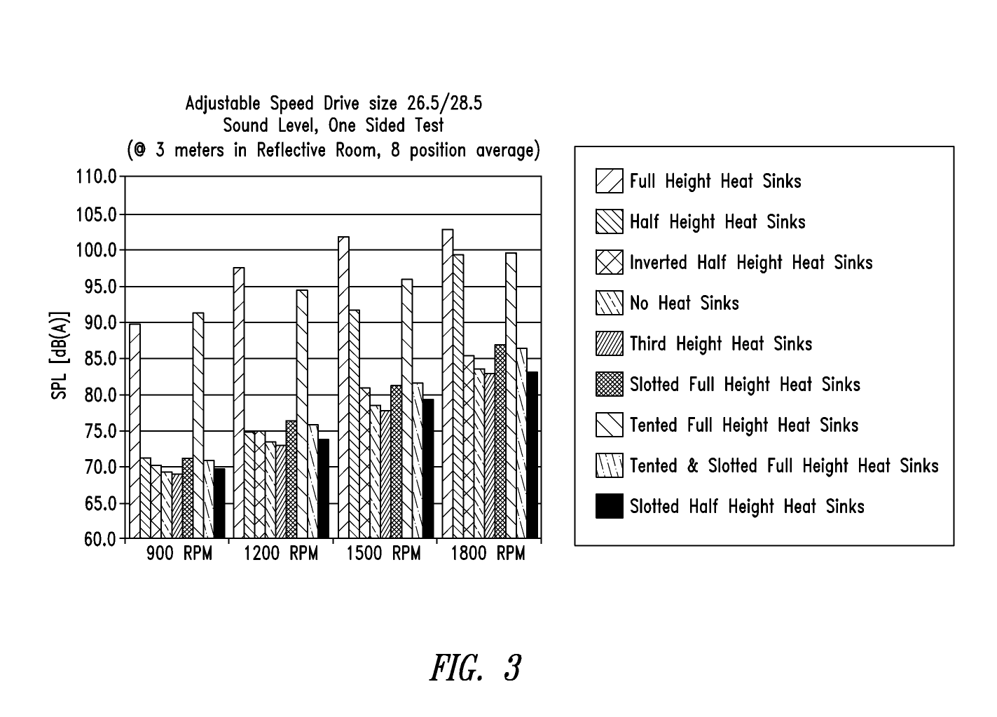

As noted above, it has been recognized that heat sinks on adjustable speed drives can create an undesirably loud whistling noise above a threshold rotational speed of the adjustable speed drive. An evaluation of several heat sink profiles revealed that the whistle noise is a function of heat sink fin height, length, and rotational speed of the adjustable speed drive. FIG. 3 shows the sound level generated from one side of an adjustable speed drive when operated with no heat sinks as well as different heat sink configurations at 900 rotations per minute (rpm), 1200 rpm, 1500 rpm, and 1800 rpm.

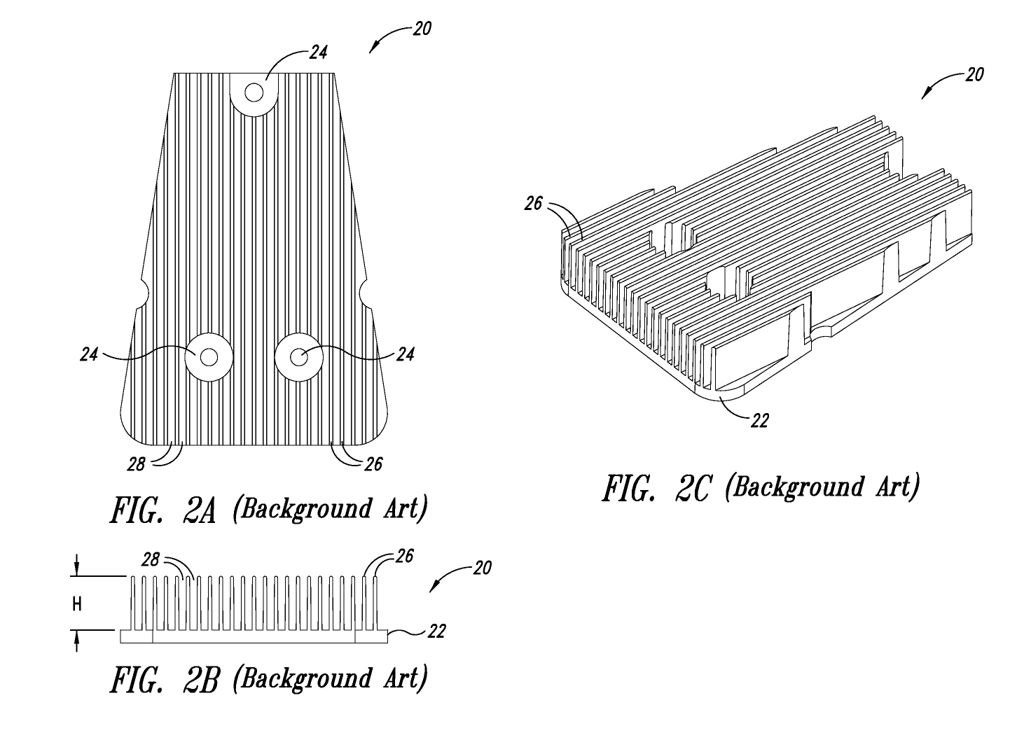

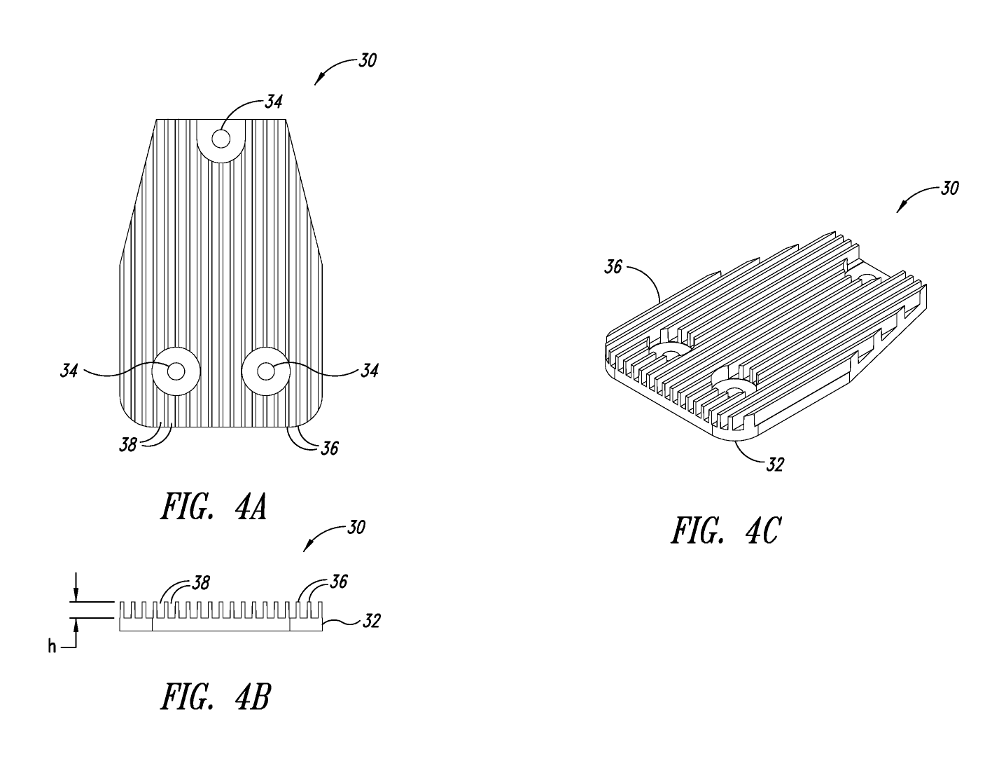

Various heat sink heights were tested, including full height heat sinks, half height heat sinks, and third height heat sinks. FIGS. 2 and 4 respectively illustrate examples of full and half height heat sinks. Each of the fins 26 of the heat sink 20 in FIGS. 2A-2C has a height H of about 0.80 inches above the base 22. The heat sink 30, shown in FIGS. 4A-4C, includes a base 32 from which includes a plurality of fins 36. The fins 36 have a height h that is about 0.40 inches, or half the height of the height H of the heat sink 20 shown in FIGS. 2A-2C. The fins 36 define channels 38 in the heat sink element 30. The heat sink element 30 can be secured to a conductor rotor via the holes 34 in the base 32.

As shown in FIG. 3, reducing the height of the fins of the heat sink resulted in a significant reduction in noise generation for operations at low speeds. For example, the amount of noise generated by the half height heat sink configuration on the adjustable speed drive operated at 900 and 1200 rpm was comparable to that generated by the adjustable speed drive that did not have any heat sinks. However, as the speed was increased to 1500 rpm, the noise generated by the half heat sink configuration increased to greater than 90 decibels, compared to the less than 80 decibels for no heat sinks, and greater than 100 decibels for full height heat sinks. As the speed was increased to 1800 rpm, the noise generated by the half heat sink configuration was within five decibels of the noise generated by the full height heat sinks, and was about 15 decibels greater than the noise generated by the drive unit with no heat sinks. Notably, the noise benefits persisted across each speed of operation that was tested for heat sinks that were one third the height of the full height heat sinks.

Heat sinks having a tented profile were also tested. These heat sinks have a variable fin height across the heat sink. Fin heights increase linearly from one side of the heat sink to a maximum fin height at the center, and then decrease linearly to the other side of the heat sink. The resulting profile resembles a tent. As shown in FIG. 3, the tented profile heat sinks did not achieve as significant a noise reduction as the half height heat sinks for 900, 1200, and 1500 rpm, and was comparable to the noise reduction of the half height heat sink at 1800 rpm.

It was further observed that, unexpectedly, the sound level generated by an adjustable speed drive could be greatly reduced without reducing the height of the heat sinks merely by including transverse slots across the fins of the heat sinks. As shown in FIG. 3, the noise benefits of slotted heat sinks persisted even as the speed of the adjustable speed drive was increased from 900 rpm to 1800 rpm for full height heat sinks with slots, tented heat sinks that include slots, and half height heat sinks that include slots.

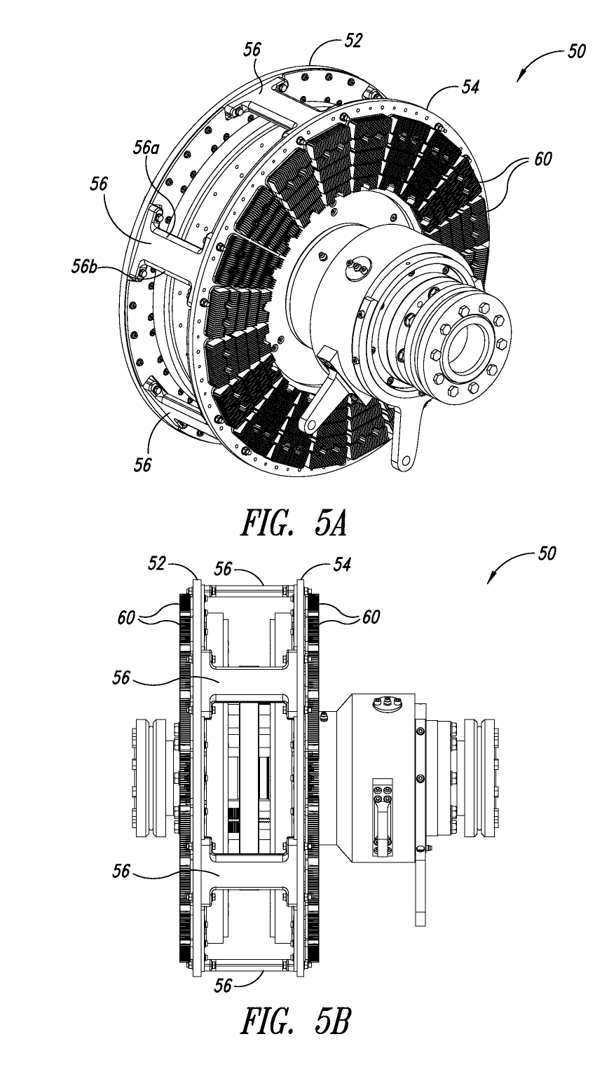

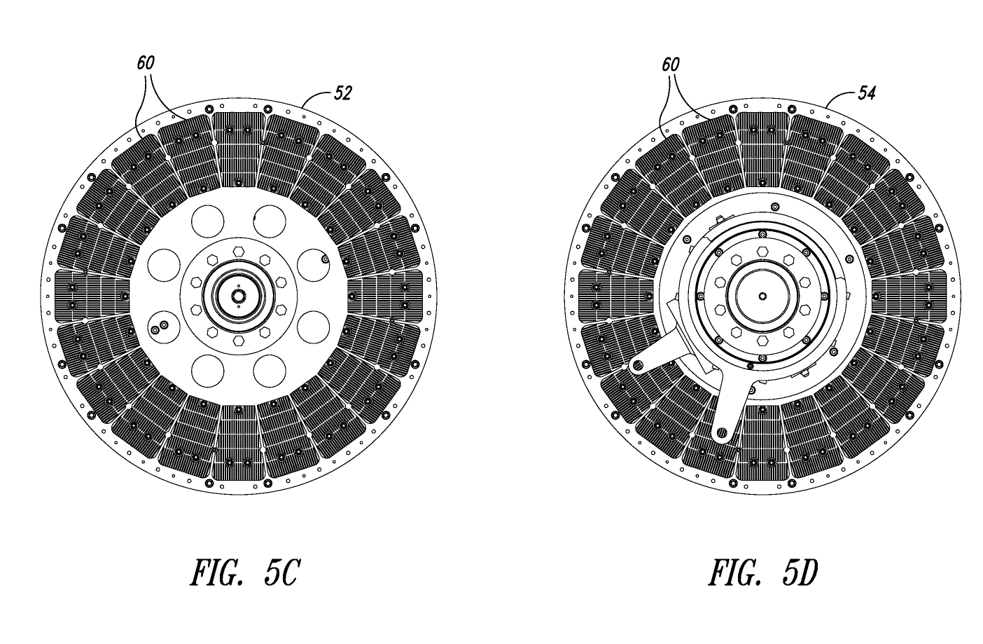

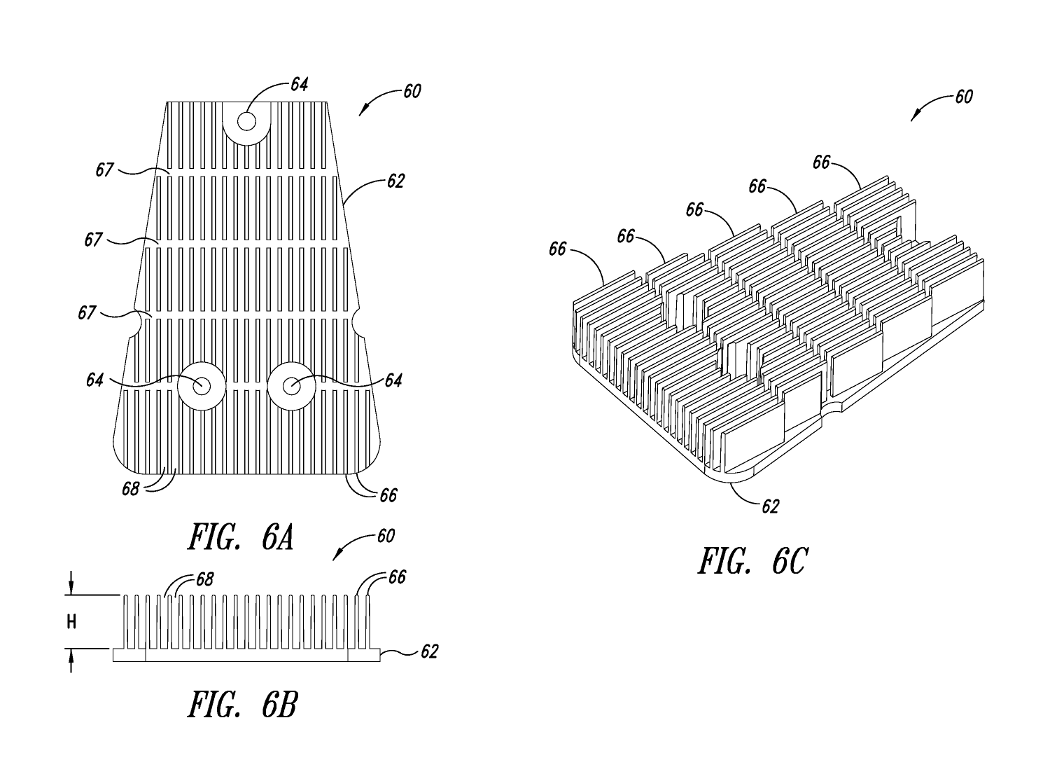

FIGS. 5A-5D illustrate an adjustable speed drive 50 that includes slotted, full-height heat sinks 60. The adjustable speed drive 50 includes two conductor rotors 52 and 54 that are coupled via spacers 56. The conductor rotors 52 and 54 include a rotor made of a conductive material, such as aluminum, copper, or brass. FIGS. 6A-6C illustrate the slotted heat sink elements 60 in greater detail. Each heat sink element 60 includes a base 62 from which extend a plurality of fins 66. The fins 66 define channels 68 therebetween and extend a full-height H above the base 62. The heat transfer element 60 further includes a plurality of slots 67 that extend substantially transverse to the direction of extension of the fins 66, thereby dividing the fins into a plurality of groups in the radial direction with respect to an axis of rotation of the conductor rotors. The heat transfer elements 60 can be affixed to the conductor rotors 52 and 54 via mounting holes 64.

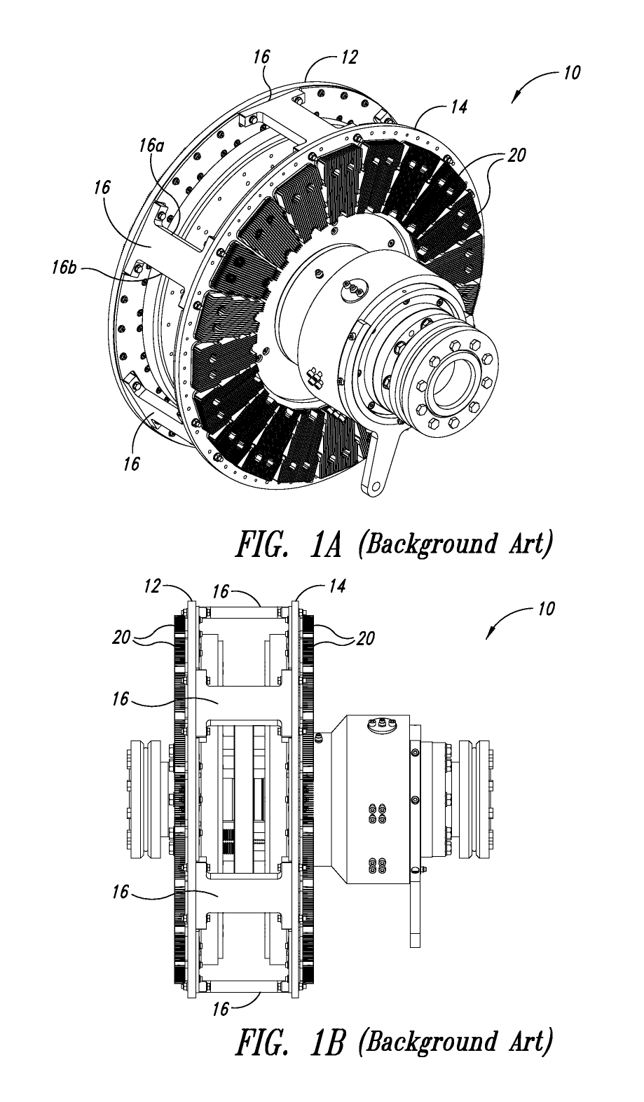

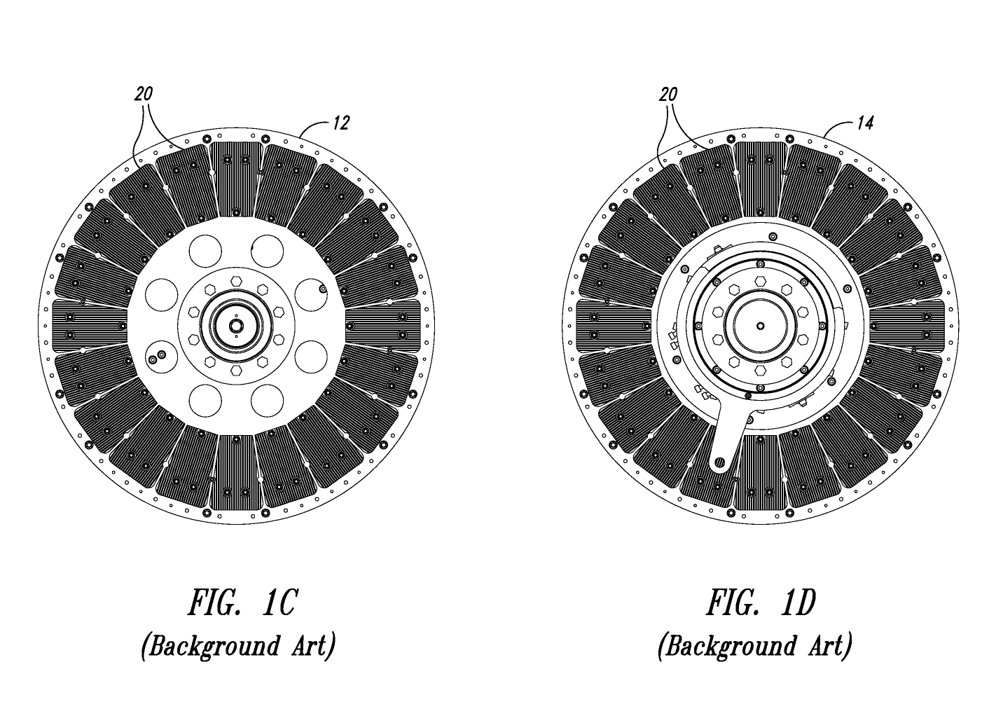

It was further observed that noise savings could also be obtained by changing the shape of the spacer elements 56 that couple the conductor rotors 52 and 54. Specifically, as shown in FIG. 5A, each spacer 56 includes a radius 56a and 56b on leading and trailing edges thereof. By contrast, as shown in FIG. 1A, the spacers 16 include abrupt edges 16a and 16b on leading and trailing edges thereof.

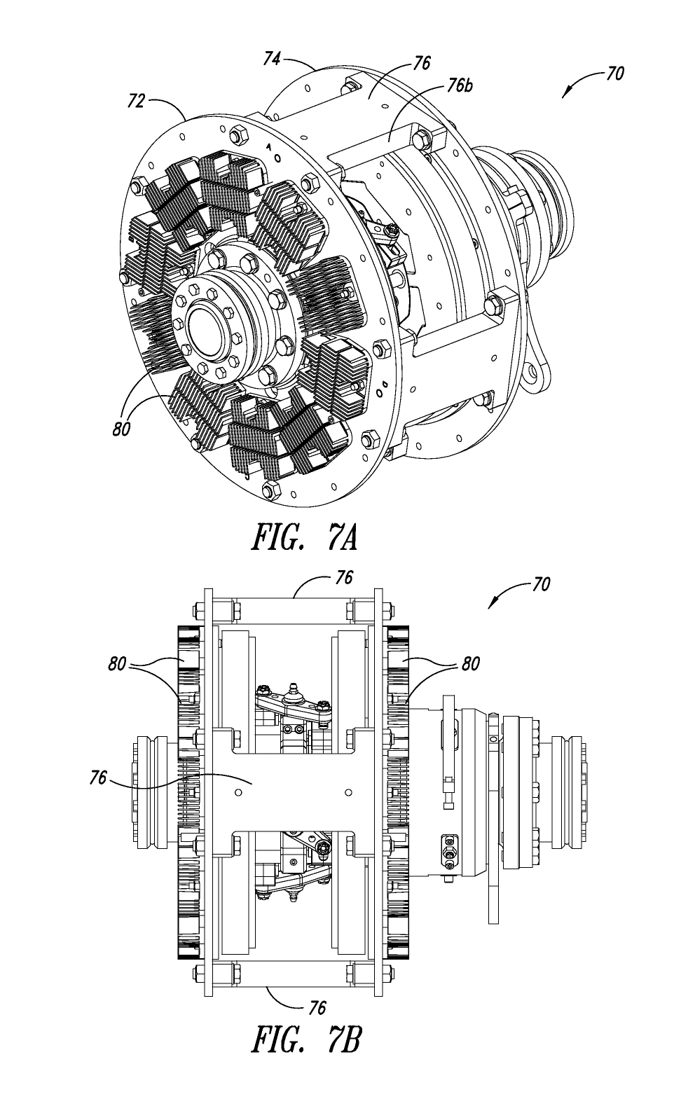

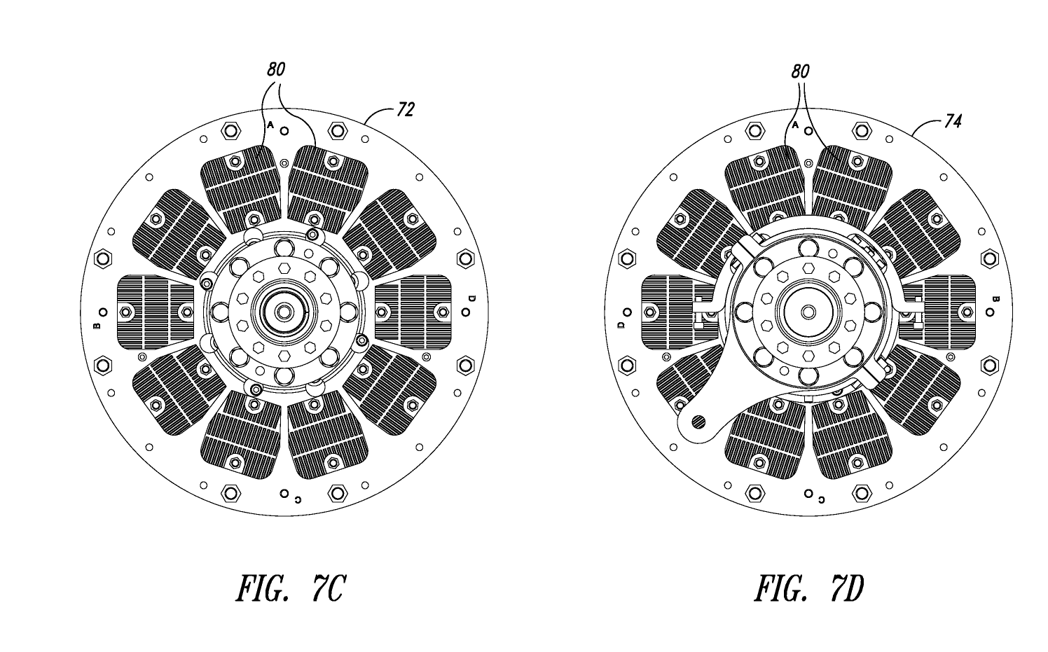

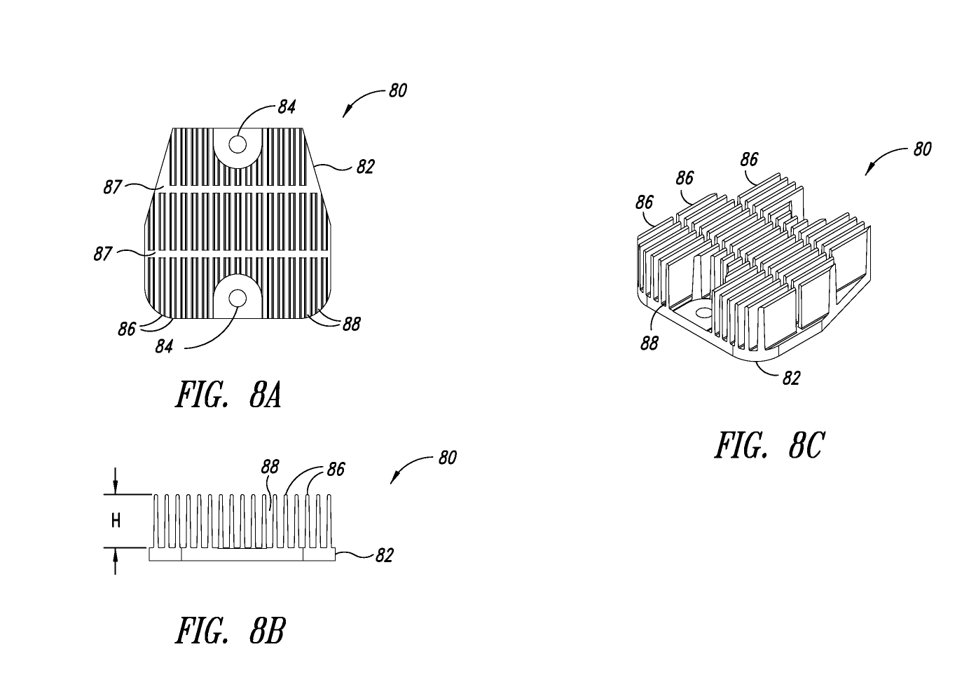

It was further observed that the number of slots used in the heat sink transfer element can vary depending upon the size of the adjustable speed drive. FIGS. 7A-7D illustrate an adjustable speed drive according to another aspect of the present disclosure. The adjustable speed drive 70 includes conductor rotor elements 72 and 74 coupled by spacers 76 having leading and trailing edges 70a and 70b. Heat transfer elements 80 are affixed to the opposing faces of the conductor rotor elements 72 and 74. FIGS. 8A-8C illustrate the heat transfer elements 80 in greater detail. Each heat transfer element 80 includes a base 82 from which extend fins 86 to a height H. The fins 86 define a plurality of channels 88. Two slots 87 transect the fins 86. The heat transfer element 80 can be secured to the conductor rotor 72 or 74 via the mounting poles 84 in the base 82.

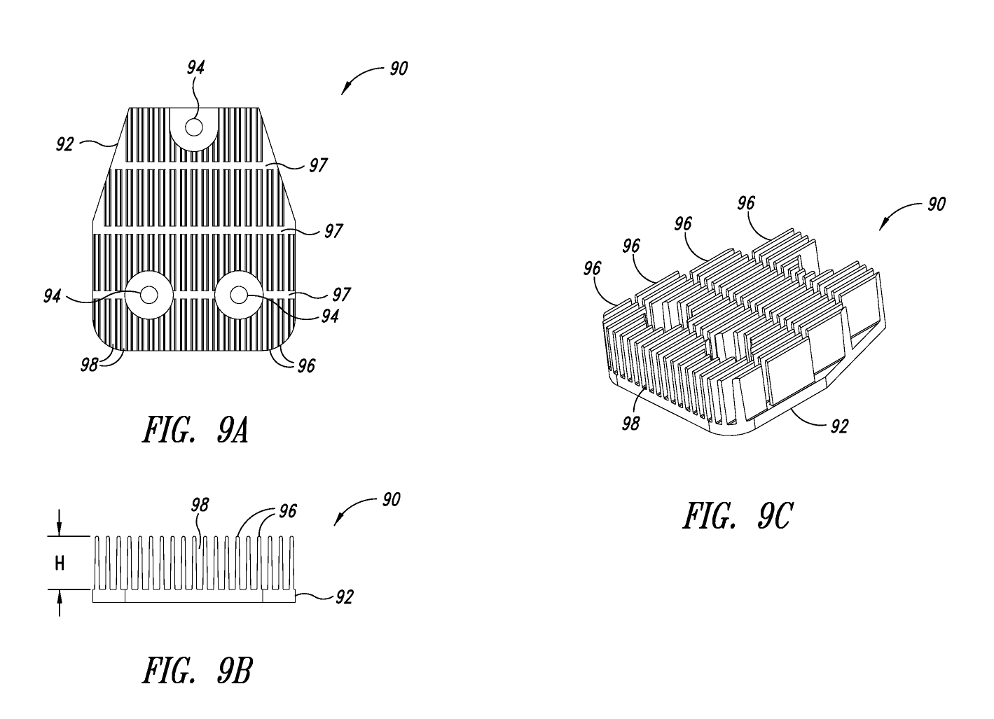

FIGS. 9A-9C illustrate a heat transfer element that includes three transverse slots. The heat transfer element 90 includes a base 92 from which extend fins 96 to a height h. The fins 96 define channels 98. Transverse slots 97 divide the plurality of fins into four groups. The heat transfer elements 90 can be secured to conductor rotor elements via mounting holes 94 in the base 92.

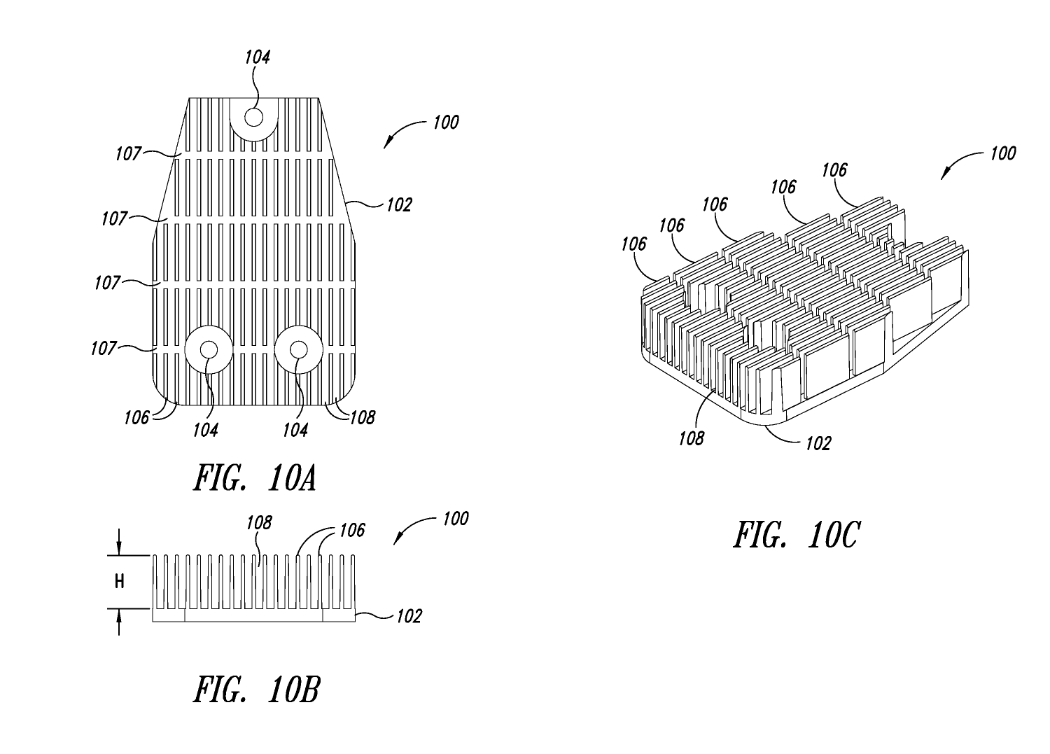

FIGS. 10A-10C illustrate a heat transfer element 100 that includes four transverse slots 107. The transverse slots 107 divide and separate a plurality of groups of fins 106 that extend from a base 102. The fins reach a height H. The heat transfer element 100 can be affixed to a rotary conductive element via mounting holes 104 in the base 102.

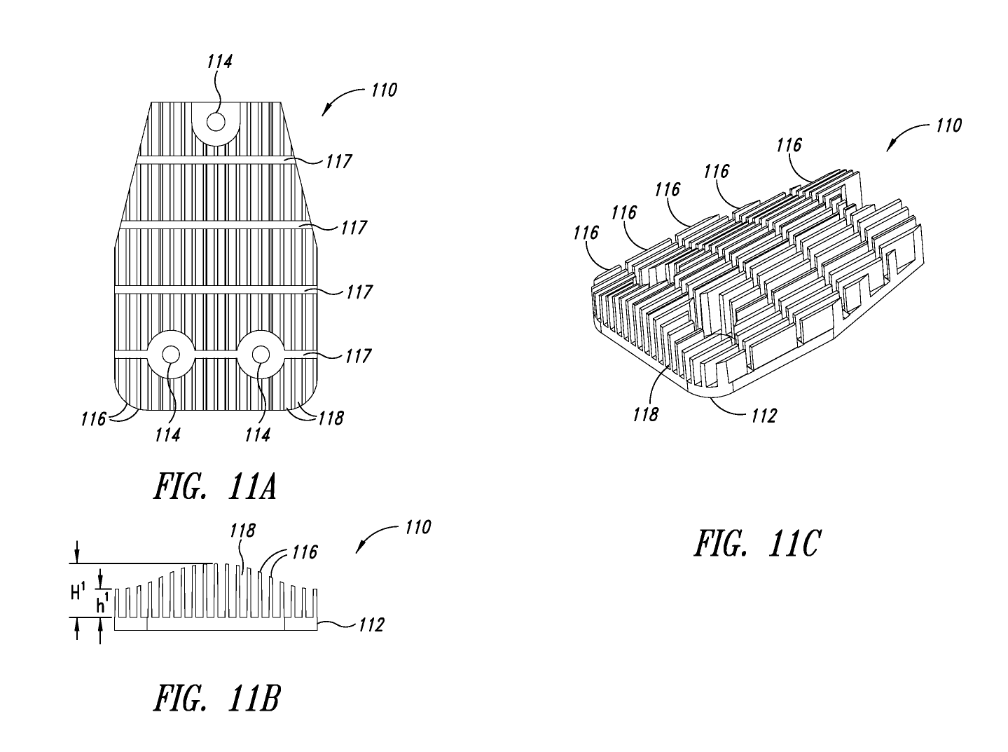

FIGS. 11A-11C illustrate a heat transfer element 110 according to another aspect of the present disclosure. Fins 116 extend from a base 112. The fins 116 define channels 118 therebetween. Slots 117 divide and separate the fins 116 into a plurality of groups. The base 112 includes mounting holes 114 to secure the heat transfer element to a conductor rotor. Unlike previous examples, the height of the fins 116 varies to create a curved profile. In particular, as shown in FIG. 11B, the fins vary in a nonlinear fashion from a minimal height h′ to a maximum height H′.

In addition to new installations, noise improvements can be achieved by replacing existing heat transfer elements with any of the improved heat transfer elements described herein. For example, full height heat transfer elements can be replaced with half-height heat transfer elements for low-speed applications. For higher speed applications, full height heat transfer elements can be replaced with slotted heat transfer elements, having the appropriate height necessary for the desired heat transfer.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A heat sink element for an adjustable speed magnetic drive unit operable by relative rotation of a conductor rotor assembly and a magnet rotor assembly, the heat sink element comprising:
a base portion that includes a mounting face that is sized and dimensioned to be coupled to the conductor rotor assembly, and an opposing convective heat transfer face;
a plurality of groupings of fins extending from the convective heat transfer face of the base portion, adjacent fins in each grouping of fins separated by a channel that extends along a longitudinal direction of the fins, the plurality of groupings of fins being separated by at least one slot that extends substantially transverse to the longitudinal direction.

2. The heat sink element of claim 1, wherein a height of the fins in each grouping varies across the grouping.

3. The heat sink element of claim 2, wherein the height of the fins increases linearly towards a centerline of the heat sink element to form a tented profile.

4. The heat sink element of claim 2, wherein a height of the fins in each grouping varies across the grouping to form a non-linear, curved profile.

5. The heat sink element of claim 1, wherein the plurality of groupings of fins are separated by more than two slots that extend substantially transverse to the longitudinal direction.

6. An adjustable speed magnetic drive unit, comprising:
a magnet rotor assembly;
a conductor rotor assembly positioned relative to the magnet rotor assembly such that there is an air gap between the magnet rotor assembly and the conductor rotor assembly, and such that relative rotation of the conductor and magnet rotor assemblies induces a magnetic coupling across the air gap; and
a heat sink assembly coupled to the conductor assembly, the heat sink assembly including a plurality of groupings of fins arrayed in a substantially circumferential direction relative to an axis of rotation of the conductor assembly, the plurality of circumferential arrays of fins being separated by at least one slot that extends substantially transverse to a radial direction relative to the axis of rotation of the conductor assembly.

7. The adjustable speed magnetic drive unit of claim 6, wherein the heat sink assembly includes a plurality of heat sink elements that are arranged on an external surface of the conductor rotor assembly, each heat sink element including the plurality of groupings of fins.

8. The adjustable speed magnetic drive unit of claim 7, wherein, on at least one of the heat sink assemblies, a height of the fins within each of the plurality of groupings of fins varies across the respective grouping of fins.

9. The adjustable speed magnetic drive unit of claim 8, wherein, on the at least one of the heat sink assemblies, the fins define a tented profile.

10. The adjustable speed magnetic drive unit of claim 8, wherein, on the at least one of the heat sink assemblies, the fins define a curved profile.

11. The adjustable speed magnetic drive unit of claim 7, wherein each heat sink element includes more than two slots that extends substantially transverse to the radial direction.

12. A method of reducing noise generated by an adjustable speed magnetic drive unit that is operable by relative rotation of a conductor rotor assembly and a magnet rotor assembly, the method comprising:
removing a first heat sink element from the conductor rotor assembly, the first heat sink element including a first plurality of fins that extend in a substantially radial direction relative to an axis of rotation of the conductor rotor assembly; and then
coupling a second heat sink element to the conductor rotor assembly in place of the first heat sink element, the second heat sink element including a second plurality of fins that extend in a substantially radial direction relative to the axis of rotation of the conductor rotor assembly, a total exposed surface area of the second plurality of fins being less than a total exposed surface area of the first plurality of fins.

13. The method of claim 12, wherein an average fin height of the first plurality of fins is greater than an average fin height of the second plurality of fins.

14. The method of claim 12, wherein the first plurality of fins extend uninterrupted in the radial direction on the first heat sink element, and the second plurality of fins include at least one slot that extends substantially transverse to the radial direction and separates the second plurality of fins into at least two radial groupings.

15. The method of claim 14, wherein an average fin height of the first plurality of fins is greater than an average fin height of the second plurality of fins.

16. The method of claim 13, wherein an average fin height of the second plurality of fins is one third an average fin height of the first plurality of fins.

17. The method of claim 13, wherein an average fin height of the second plurality of fins is one half an average fin height of the first plurality of fins.
